(19) United States
(12) Patent Application Publication
(10) Pub. No.: US 2009/0173190 A1
(43) Pub. Date: Jul. 9, 2009

(54) REMOTE MANAGEMENT DEVICE AND RESCUE TOOL

(76) Inventor: Tyler Klegin, Marion, WI (US)

Correspondence Address: GODFREY & KAHN S.C., 780 NORTH WATER STREET, MILWAUKEE, WI, 53202, US

(21) Appl. No.: 12/350,129

(22) Filed: Jan. 7, 2009

Related U.S. Application Data
(60) Provisional application No. 61/019,487, filed on Jan. 7, 2008.

(51) Int. Cl. B25B 23/16

(52) U.S. Cl. 81/177.2

(57) ABSTRACT

A tool for engaging and actuating support struts that may be used during or as part of a below ground rescue. The struts to be engaged may also be used to support unstable structures that must be entered or accessed during emergency response situations. The tool may include a tool head with a face including a plurality of teeth configured to remotely engage a locking mechanism of the struts or other devices. Other possible features of the tool head may include hooks or other structures for engaging or moving other objects.

### CROSS-REFERENCE TO RELATED APPLICATION

The present application claims priority to earlier-filed and commonly owned U.S. Provisional Patent Application, Ser. No. 61/019,487, filed on Jan. 7, 2008, the disclosure of which is incorporated herein by reference.

### TECHNICAL FIELD

The present disclosure relates generally to tools and devices for remotely actuating rescue devices and assisting in rescues.

### BACKGROUND

In many trench rescue situations, extendable struts or braces may be used to aid in shoring up potentially unstable walls to secure the area for rescue workers to assist victims who may have been trapped and/or injured in the trench. Until such bracing and shoring can be accomplished, often the rescue workers are unable to enter the trench to assist the victims.

A variety of struts or braces are being used currently by trench rescue teams and are available from numerous manufacturers and resellers. Many of these struts may be positioned within the trench in a collapsed state in conjunction with other shoring materials such as sheets, beams, cribbing, etc. When in place, the struts can be remotely extended through mechanical, pneumatic or hydraulic means to engage the shoring materials and/or the trench walls. However, a common characteristic of the operation of these conventional devices is that a person needs to visit the strut once extended remotely to engage a mechanical safety lock to secure the strut in the desired extended position. This permits the extension means to be disconnected from the strut and provides a safer, more secure rescue environment. During the locking process, a worker is required to enter the unsecured and potentially unstable and hazardous area of the trench to engage the lock.

The same or similar struts may also be used to secure unstable structures or features adjacent an industrial or transportation accident scene. For example, in a rollover car crash, where the car is left inverted and unstable on its roof, struts can be positioned to support and stabilize the vehicle while the rescue of the vehicles occupants is carried out. Once the struts are positioned and extended to their desired length, a worker must move under the vehicle to engage the locks of the strut and remove the actuation means connection.

Any of these workers accessing and actuating the locks of the strut may be exposed to unnecessary hazards due to the unsecured nature of the work site until the struts are locked.

Improvements to the locking of the extended struts in the desired position are desirable.

### BRIEF DESCRIPTION OF THE DRAWINGS

The accompanying drawings, which are incorporated in and constitute a part of the description, illustrate several aspects of the invention and together with the description, serve to explain the principles of the invention. A brief description of the drawings is as follows:

FIG. 1 is a photograph of conventional struts used to shore up a trench.

FIG. 2 is a diagrammatic cross-section of a trench with shoring forms, supports and struts positioned between opposing walls of the trench.

FIG. 3 is a side view of a tool head according to the present disclosure.

FIG. 4 is a top view of the tool head of FIG. 3.

FIG. 5 is a side view of an alternative embodiment of a tool head according to the present disclosure.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

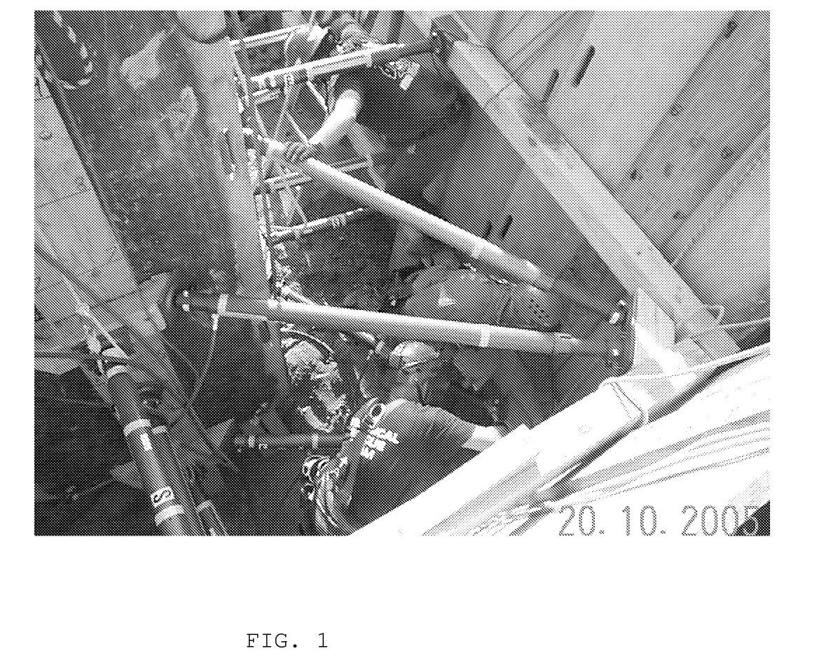

FIG. 1 illustrates a trench rescue setting where a variety of struts or extendable braces have been used in conjunction with beams, sheets and other shoring materials to support and stabilize the sides of the trench. This stabilization will permit rescue workers to safely access a location of a victim within the trench to provide emergency care and rescue services as needed.

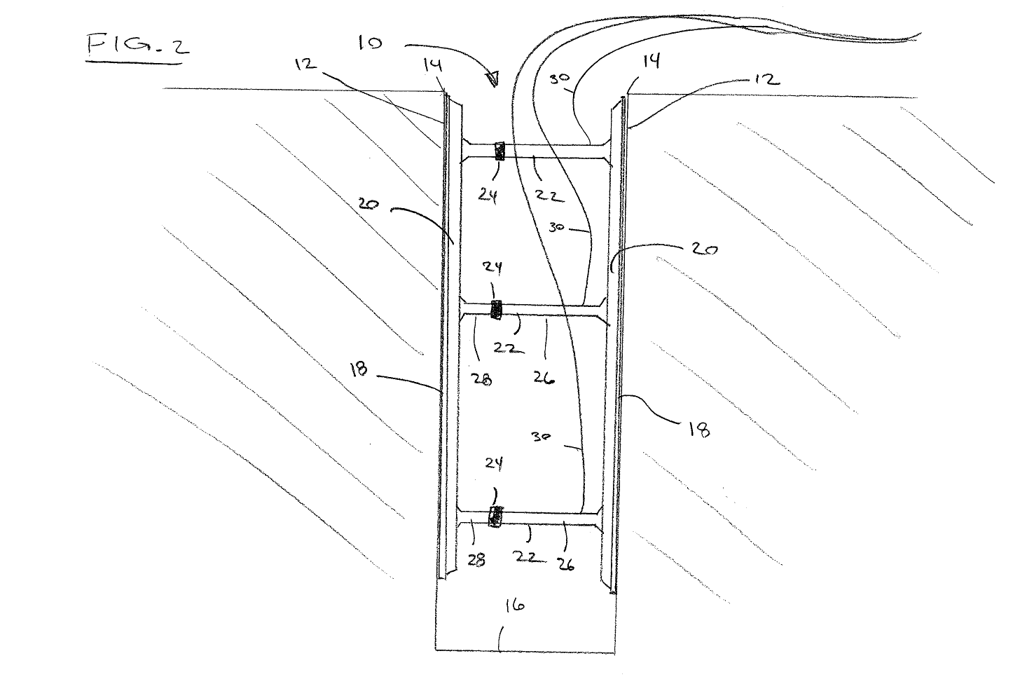

In FIG. 2, a trench 10 may have one or more exposed earthen walls 12 extending from an upper edge 14 to a trench bottom 16. If a worker is trapped on or near bottom 16, walls 12 may need to be braced to support the walls while treatment and rescue of the worker takes place. As shown in FIG. 1, a plurality of sheets or forms 18 may be placed against walls 12 to support them against collapse. One or more vertical supports 20 may be placed along forms 18 or may be positioned to extend horizontally along the forms. A plurality of extendable struts 22 extend between supports 20 on opposite walls 12 to press the supports and forms against walls 12.

To place the forms and supports in position to support walls 12, struts 22 are extendable, with a first section 26 and a second section 28 positioned within and slidable in first section 26. A locking ring 24 is positioned about second section 28 and may be threaded about the second section to allow it to moved along the exposed length of second section 28. To place the struts within trench 10, second section 28 would be slid into first section 26 so that the length of strut 22 is less than the width of trench 10 at the point the strut will be placed. An actuation connection 30 may also be attached to the strut at this time. Once positioned within trench 10, actuation line 30 may provide pressure to slide second section 28 outward from first section 26 until the extreme ends of the two sections engage the supports or forms within the trench and are exerting a desired amount of force against trench walls 12. Actuation line may be connected to a pneumatic pressure source or a hydraulic pressure source, depending on the configuration of struts 22.

Once the strut is extended as desired, locking ring 24 is moved along second section 28 until it engages an inner end of first section 26. With the locking ring threadably engaging second section 28 and engaging an inner end of first section 26, strut 22 is now fixed into the desired length providing pressure against trench walls 12 and the actuation line 30 can be removed from the strut.

Conventional approaches to moving locking ring 24 into position to fix the extension of strut 22 involve rescue workers entering the trench and positioning the threads by hand. Until the rings are positioned, any failure of the actuation system may permit the strut to retract and potentially permit a partial or complete collapse of trench walls 12, possibly onto the rescue worker within the trench.

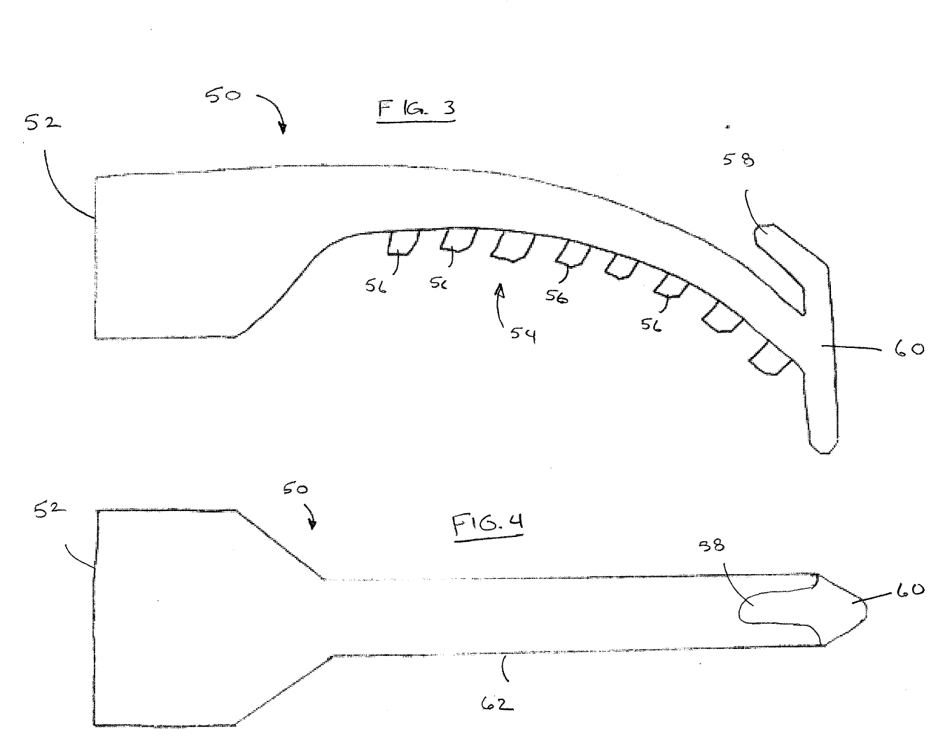

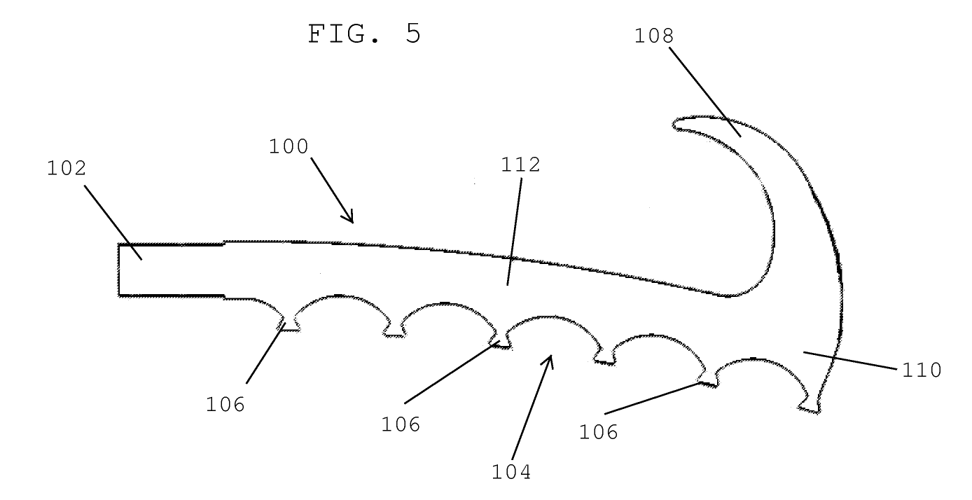

Referring now to FIGS. 3 and 4, a tool head 50 according to the present disclosure permits a rescue worker to rotate and position locking rings 24 without having to enter trench 10. Tool head 50 includes a handle mounting end 52 for mounting an extended handle (not shown). Such a handle might provide for a length adjustment permitting use of tool head 50 is a variety of trenches of differing depth or arrangement. A shorter handle may be required to access locking ring 24 in narrow, shallow or obstructed trenches. A longer handle may be desired for deeper trenches or for situations when it is not possible to closely approach the strut to be locked.

A lock ring engagement face 54 is included along a central portion 62 of tool head 50 between handle mounting end 52 and distal end 60. Positioned along at least a portion of the length of face 54 may be a plurality of ring engagement teeth 56. Often, an outer surface of locking ring 24 will be knurled or may include a plurality of evenly spaced recesses. Teeth 56 are preferably configured to engage the features of the outer surface of locking ring 24 so that tool head 50 may be used to rotate locking ring 24 about threads on an outer surface of second section 28 to engage an inner end of first section 26. The teeth 56 shown are illustrative only and it is anticipated that a variety of configurations of teeth may be used to engage the locking ring of the particular strut used.

In addition, there some configurations of struts 22 that may include a locking pin that is positioned through second section 28 through one of a plurality of opening extending through the section. The pin is preferably inserted in the opening closest to the inner end of first section 26. Lock ring 24 may be threaded to an outer surface of first section 26 and rotated along the threads over the inner end until the locking ring engages the pin to fix the length of the strut. Such a lock ring about the first section may be similarly configured and positioned with tool head 50 as described above. To aid in the positioning of the pin through the second section, tool head 50 may include a pin hook 58 adjacent distal end 60. The pin may include a loop to slip over pin hook 58. Tool head 50 could then be used to position the pin within the desired opening through second section 28 and then be used to rotate the locking ring into position using face 54 and teeth 56.

Use of tool head 50 with an appropriate handle will allow a rescue worker to secure struts 22 within trench 10 without having to enter the trench before the walls 12 are braced and secured.

As described above, tool head 50 may also be used to position locking ring 24 away from an inner end of first section 26 to permit strut 22 to be collapsed for removal from trench 10, again, without requiring a rescue to be within a potential unsupported trench. Alternatively, tool head 50 could be used to retract a locking ring positioned about a first section engaging a locking pin, and then used to remove the locking pin, permitting the strut to be collapsed and removed from the trench.

It is anticipated that tool head 50 may be configured differently than illustrated herein, with angles and curves designed to more closely match the particular size and shape of the strut being used. While the tool head is described only with regard to its configuration to address particular uses with struts, it is understood that the tool head may also be configured to useful as a multipurpose pulling or reaching tool. No particular claim is made to the materials used to construct the tool head according to the present disclosure. The tool head may be used to actuate other devices beyond rescue struts. No particular claim is made to a particular size of the tool head.

FIG. 5 illustrates a second embodiment of a tool head 100 according to the present disclosure. Tool head 100 includes handle mounting end 102 and a distal end 110. As shown above with regard to tool head 50, handle mounting end 52 may be configured to receive an end of a handle to which tool head 50 may be mounted. As shown in FIG. 5, handle mounting end 102 may be configured to be received within an end of a handle to which the tool head may be mounted.

A central portion 112 includes a face 104 on which are positioned a plurality of teeth 106. It is anticipated that face 104 may be concave to enable more positive engagement of locking rings of struts to be engaged by tool head 100, as shown in the non-limiting examples above. However, it is also within the scope of the present disclosure to have other configurations of face 104 or 54 which may be flat or convex, providing the teeth positioned on the faces are configured to engage and actuate locking elements of struts or other emergency response equipment.

Opposite face 104, a hook 108 may be positioned adjacent distal end 110. Hook 108 may be configured to engage elements of the emergency equipment such as the struts illustrated in FIGS. 1 and 2, above. In addition, hook 58 may be sized or configured to permit tool head 100 to be used to engage, move and lift other equipment or objects that may be in or around the emergency response site. Tool head 100 may be incorporated into a multipurpose tool that may be used in other situations where struts or similar emergency equipment is not utilized. By making tool head 100 from a suitable durable material, the tool head may be used as a general purpose pike during typical fire or rescue operations and then used as a strut engaging tool in below ground operations. More than one hook or strut engagement device may be mounted to the tool head within the scope of the present disclosure.

Tool heads 50 and 100 may be constructed as a single unitary piece or may be assembled by the durable connection of a plurality of smaller components. It is anticipated that any suitable material may be used to construct tool heads 50 and 100, provided the material is sufficiently rigid to resist deformation and permit actuation of the struts or other emergency devices. As the tool heads may also be incorporated into general purpose fire or rescue tools, it may be desirable that the tools head be made of a durable material that is resistant to heat or solvents as well, and that the hook opposite the strut engagement face may be sufficiently rigid or resistant to deformation to permit adequate pressure to be applied to locking pins or for lifting or pushing other objects.

No dimensions or sizing is implied in the present disclosure. Struts and other rescue devices to be engaged by the tool heads of the present disclosure may vary in size and in the nature of the lock rings or pins to be actuated. It is anticipated that the size of the tool head and number of teeth incorporated into the tool head may be adapted for the particular strut or other device to be actuated, and that such adaptations are within the scope of the present disclosure.

Various alternatives and embodiments are contemplated as being within the scope of the following claims particularly pointing out and distinctly claiming the subject matter regarded as the invention.

What is claimed is:

1. A remote strut actuation tool for an extendable rescue strut, the tool comprising:
a handle attachment end and an opposite distal end;
a locking ring actuation face positioned between the two ends;
the actuation face including a plurality of surface features configured to engage a locking ring of the rescue strut and permit the ring to be positioned laterally along the strut to fix the strut at a desired length.

2. The tool of claim 1, further comprising the surface features of the face are a plurality of teeth extending from the face.

3. The tool of claim 1, further comprising the face having a convex surface from which the surface features extend.

4. The tool of claim 1, further comprising a hook positioned opposite the face adjacent the distal end.

5. The tool of claim 1, further comprising the handle attachment end configured to receive an end of a handle.

6. The tool of claim 1, further comprising the handle attachment end configured to be received within an end of a handle.
